(19) United States
(12) Patent Application Publication
(10) Pub. No.: US 2004/0123269 A1
(43) Pub. Date: Jun. 24, 2004

(54) Method of creating multimedia content using synchronized multimedia integration language and multimedia content made thereby

(75) Inventors: Jin-Woo Hong, Seoul (KR); Dae-gyu Bae, Suwon-si (KR); Hyun-ah Sung, Seoul (KR); Ju-han Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/673,364

(22) Filed: Sep. 30, 2003

(30) Foreign Application Priority Data
Nov. 28, 2002 (KR) 2002-74641

(51) Int. Cl. G06F 9/44

(52) U.S. Cl. 717/114

(57) ABSTRACT

Provided are a method of creating multimedia content using a Synchronized Multimedia Integration Language (SMIL) and multimedia content created by the method. The multimedia content includes a first element and a second element. The first element has an attribute that initializes variables. The second element has an attribute that implements a memory function by expressing operations on the variables.

### BACKGROUND OF THE INVENTION

This application claims the benefit from Korean Patent Application No. 10-2002-0074641, filed on Nov. 28, 2002, in the Korean Intellectual Property Office, the disclosure of which is incorporated herein in its entirety by reference.

1. Field of the Invention

The present invention relates to the Synchronized Multimedia Integration Language (SMIL), and more particularly, to a method of creating multimedia content using the Synchronized Multimedia Integration Language (SMIL) and the multimedia content created thereby.

2. Description of the Related Art

The Synchronized Multimedia Integration Language (SMIL) is a markup language for multimedia layout or multimedia presentation based on the Extensible Markup Language (XML) recommended by the World Wide Web Consortium (W3C). SMIL is used to integrate various types of separate media data such as audio data, video data, musical instrument digital interface (MIDI) data, text, images, and the like into synchronized multimedia content for controlling the play time of the respective media data, and for controlling and dividing a screen layout.

As with the Hypertext Markup Language (HTML), SMIL can be created through a text editor. SMIL also has a small number of elements. Moreover, SMIL is easy to learn because its grammar is consistent with XML. Thus, a user can create multimedia content more easily using SMIL.

Multimedia content is widely used for education. For example, when education content is created using SMIL for selection-type questions and answers thereof, the results for user inputs can be displayed by using EventBase or SyncBase. An example for this is as follows.

```
.
<par>
  <image id=“img1”.../>
  <image id=“img2”.../>
  <image id=“img3”.../>
  <text id=“rightAnswer”...
    begin=“img1.activateEvent”
    .../>
  <text id=“wrong”...
    begin=“img2.activateEvent;
    img3.activateEvent;
    img4.activateEvent”.../>
.
```

The above example shows a case where the image with identifier “img1” represents the right answer. If a user selects the image with identifier “img1”, a corresponding event is generated, and a text with identifier “rightAnswer” is displayed. If the other images with identifiers “img2”, “img3”, and “img4” are selected by the user, corresponding events are generated, and a text with identifier “wrong” is displayed.

However, with SMIL, it is not possible to assign marks for tracking total answer results or allot different marks based on individual test item importance. This is because SMIL does not have a memory function capable of storing variables. It is possible to implement the memory function to store the variables in SMIL by programming the functionality into SMIL. However, in order to program the functionality into SMIL, it is required to have full knowledge of a new programming language. In addition, since the data size of the multimedia content becomes larger, and the multimedia content is transmitted through a network, data traffic increases. Also, a separate interpreting engine for interpreting the programming language is needed when the multimedia content is reproduced. Considering the increasing demand for transmitting multimedia content to mobile terminals, an increase in traffic and an additional interpreting engine are not acceptable.

### SUMMARY OF THE INVENTION

The present invention provides a method of creating multimedia content that allows simple and easy design of a memory function using Synchronized Multimedia Integration Language (SMIL) without involving additional programming knowledge, and the multimedia content created by the method.

According to one exemplary aspect of the present invention, there is provided multimedia content which is created using Synchronized Multimedia Integration Language (SMIL). The multimedia content comprises a first element which has an attribute that initializes variables and a second element which has an attribute that implements a memory function by expressing an operation on a variable.

The multimedia content further comprises a third element which expresses results of the operation on the variables. The third element has an attribute that expresses an executing condition of the third element.

The attribute of the second element expresses at least one from the group of an arithmetic operation, a relational operation, a logical operation, and an “if” phrase of the variables. Preferably, the attribute of the second element contains a processing condition for processing the operation on the variables.

The operation on the variables of the second element is processed when the second element is parsed.

The attribute of the first element is expressed as an attribute name =“variable=0;”, and the attribute of the second element is expressed as an attribute name=“operation on variable”.

The attribute of the first element is expressed as var=“x=0;”, and the attribute of the second element is expressed as var=“x=x♦n;” (here, ♦ is an arithmetic operator and n is a numeric value if required by the arithmetic operator). The attribute of the first element is expressed as var=“x=0;”, and the attribute of the second element is expressed as var=“count++; sum+=20;”.

The attribute of the third element is expressed as an attribute name=“executing condition of corresponding tag”. The attribute of the third element is expressed as condition=“executing condition”.

According to another exemplary aspect of the present invention, there is provided multimedia content which are created using Synchronized Multimedia Integration Language (SMIL). The multimedia content comprises at least one first element and a second element which has an attribute that expresses a function for the element and the content to be processed when the function is true.

The function is true when a rendering region of a corresponding element overlaps with a rendering region of a predetermined element, and the attribute of the second element expresses completion of rendering of the corresponding element if the function is true.

The function is true when rendering regions of the first elements overlap with one another, and the attribute of the second element expresses a beginning of rendering of the corresponding element if the function is true.

According to yet another exemplary aspect of the present invention, there is provided a method of creating multimedia content using Synchronized Multimedia Integration Language (SMIL). The method comprises initializing variables by using an attribute of a first element and (b) implementing a memory function by expressing an operation on the variables by using an attribute of a second element.

Preferably, but not necessarily, the method further comprises (c) expressing an executing condition of a third element according to results from operations on variables using an attribute of the third element.

Preferably, but not necessarily step (b) is characterized by implementing a memory function by expressing at least one from the group of an arithmetic operation, a relational operation, a logical operation, and an “if” phrase of the variables.

Preferably, but not necessarily, step (b) further comprises adding an executing condition for executing the operation on the variables. Preferably, but not necessarily, step (b) further comprises expressing the executing condition using timing attributes defined in SMIL, and the operation on the variables of step (b) is processed when a corresponding element is parsed.

Step (a) is initialized as an attribute-name=“variable=0;”, step (b) is initialized as an attribute name=“operation on variable;”, step (a) is initialized as var=“x=0;”, and the second element is initialized as var=“x=x♦n;” (here, ♦ is an arithmetic operator and n is a numeric value if required by the arithmetic operator).

Step (c) can be expressed as an attribute name=“executing condition of corresponding tag”, and preferably, expressed as var=“if phrase”.

According to yet another exemplary aspect of the present invention, there is provided a method of creating multimedia content using a Synchronized Multimedia Integration Language. The method comprises (a) defining at least one function in an element and (b) expressing content to be processed when the function is true using an attribute of the element.

Step (b) is characterized by expressing the content using an action attribute of the element.

Step (a) comprises defining the function as true when a rendering region of a corresponding element overlaps with a rendering region of a predetermined element, and step (b) is characterized by completing rendering of the corresponding element if the function is true. Preferably, but not necessarily, step (a) comprises defining a function as true when rendering regions of at least one element overlap with one another, and step (b) is characterized by starting rendering of a corresponding element using the action attribute.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a device for reproducing multimedia content according to an embodiment of the present invention;

FIG. 2 is a schematic view of Synchronized Multimedia Integration Language (SMIL) content according to an embodiment of the present invention;

FIG. 3 is a schematic view of SMIL content used to create a frame of FIG. 2;

FIG. 4 shows an example of the SMIL content in FIG. 2;

FIG. 5 shows another example of the SMIL content in FIG. 2;

FIG. 6 shows another example of the SMIL content in FIG. 2;

FIG. 7 shows another example of the SMIL content in FIG. 2;

FIG. 8 shows an example of using the variables stored by the memory function using operations on the variables implemented in FIGS. 4 through 7;

FIG. 9 shows an example of adding a processing condition for processing operations on variables;

FIG. 10 shows an example of adding a function to SMIL content according to the present invention;

FIG. 11 shows another example of adding a function to SMIL content according to the present invention;

FIG. 12 is a flowchart for explaining a method of creating multimedia content using SMIL with additional attributes, according to an embodiment of the present invention;

FIG. 13 is a flowchart for explaining a method of creating multimedia content using SMIL with additional attributes, according to another embodiment of the present invention; and

FIG. 14 is a flowchart for explaining a method of creating multimedia content using SMIL with an additional function, according to an embodiment of the present invention.

### DETAILED DESCRIPTION OF THE INVENTION

The present invention will now be described more fully with reference to the accompanying drawings, in which illustrative, non-limiting embodiments of the invention are shown.

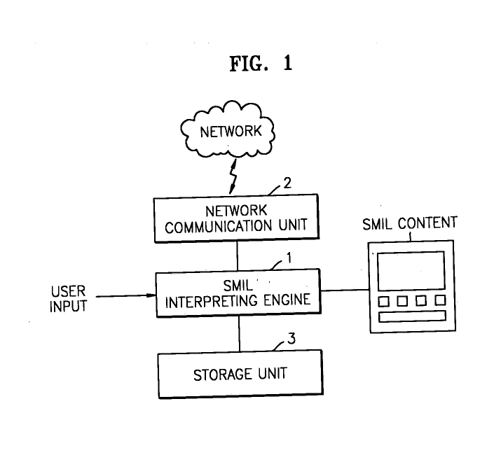

FIG. 1 is a block diagram of a device for reproducing multimedia content according to an embodiment of the present invention.

Referring to FIG. 1, a device for reproducing multimedia content according to an embodiment of the present invention includes a Synchronized Multimedia Integration Language (SMIL) interpreting engine 1, a network communication unit 2, and a storage unit 3. SMIL content denotes multimedia content which is made using SMIL and has additional attributes of defining and supporting a memory function for storing variables. That is, the SMIL content denotes content in which the memory function for storing variables is implemented. Detailed descriptions of the SMIL content will follow later.

The network communication unit 2 can connect to a network and retrieve SMIL content. The storage unit 3 stores the SMIL content. The storage unit 3 may be an information storage medium such as a hard disk, memory, an optical disk, or the like. If the storage unit 3 is an optical disk, it additionally includes an optical disk drive (not shown) for reading the SMIL content stored in the optical disk. The optical disk is removably mounted in the optical disk drive and capable of being removed.

The SMIL interpreting engine 1 parses, interprets, and executes the SMIL content. The SMIL interpreting engine 1 includes a decoder for decoding various multimedia files included in the SMIL content, e.g., audio files, image files, moving image files, or the like. In other words, the SMIL interpreting engine 1 interprets, executes, and displays the SMIL content of the network communication unit 2 or the storage unit 3 on a display (not shown). The SMIL interpreting engine 1 also receives user inputs and performs operations corresponding to the user inputs. In particular, the SMIL interpreting engine 1 parses the element of the SMIL content, which has an attribute that defines the operations on variables to implement a memory function, and processes the element if an executing condition of the element is satisfied. In addition, the SMIL interpreting engine 1 parses an element, which has an attribute that defines at least one function, and processes the element according to content to be processed if the function expressed using the attribute is true. Thus, user interaction can be supported through the use of SMIL content.

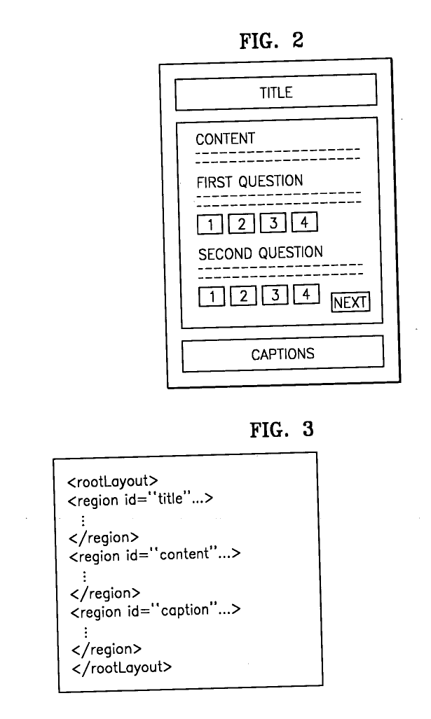

FIG. 2 is a schematic view of Synchronized Multimedia Integration Language (SMIL) content according to an embodiment of the present invention.

Referring to FIG. 2, SMIL content according to the present invention is used to represent multimedia content for education, especially, for the study of math at an elementary school level. A region for a title is provided on the top of a frame, and a region for study content is provided in the middle of the frame. Additional descriptions and guide information are displayed at the bottom of the frame while the study content is expressed.

In particular, in the middle of the frame, study content such as questions are expressed. If a user desires to view the next page, the user clicks the “NEXT” button.

FIG. 3 is a schematic view of SMIL content used to create the frame of FIG. 2.

Referring to FIG. 3, a whole frame is defined as <rootLayout . . . >, the title region as <region id=“title” . . . >, the content region as <region id=“content” . . . >, and the caption region as <region id=“caption” . . . >.

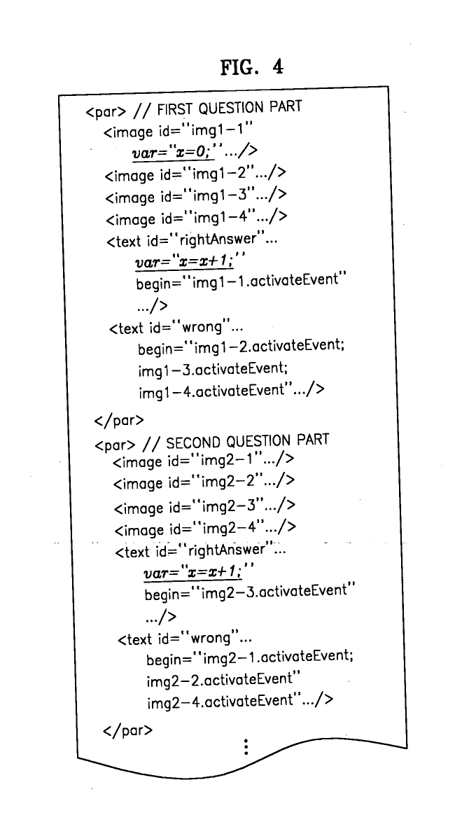

FIG. 4 shows an example of the SMIL content in FIG. 2.

Referring to FIG. 4, for the first question located in the middle frame, the right answer is an image with the identifier “img1-1”. If a user clicks the image with the identifier “img1-1”, a corresponding event is generated, and a text with the identifier “rightAnswer” is displayed. If the image of the wrong answer, i.e., the image with identifier “img1-2”, “img1-3”, or “img1-4” is clicked, a corresponding event is generated, and a text with the identifier “wrong” is displayed. The right answer of the second question is an image with the identifier “img2-3”. If the user clicks the image of the wrong answer, i.e., the image with the identifier “img2-1”, “img2-2”, or “img2-4”, a corresponding event is generated and a text with the identifier “wrong” is displayed.

In particular, according to FIG. 4, the number of right answers a user inputs can also be displayed. That is, in the element <image id=“img1-1” . . . /> of the first question part, var=“x=0;” is inserted as an attribute that initializes variables defined according to the present invention. In addition, in the element <text id=“rightAnswer” . . . /> of the first question part, var=“x=x+1;” is inserted as an attribute that implements a memory function by expressing an operation on variables according to the present invention. In the element <text id=“rightAnswer” . . . /> of the second question part, var=“x=x+1” is inserted as an attribute that implements a memory function by expressing an operation on variables according to the present invention. Thus, if the user clicks a right answer, the number of right answers that the user clicks is accumulated as the variable. Therefore, the total number of right answers before the next click can be displayed to the user.

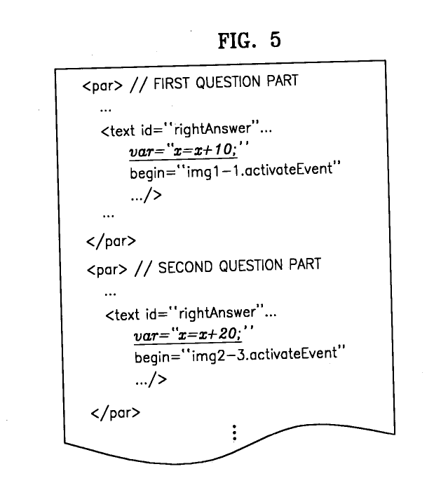

FIG. 5 shows another example of the SMIL content in FIG. 2.

According to FIG. 5, a different weight can be assigned to each question. That is, in the element <text id=“rightAnswer” . . . /> of the first question part, var=“x=x+10;” is inserted as an attribute that implements a memory function by expressing an operation on variables according to the present invention. In the element <text id=“rightAnswer” . . . /> of the second question part, var=“x=x+20;” is inserted as an attribute that also implements a memory function by expressing an operation on variables according to the present invention. Thus, a weight of 10 is assigned to the first question if the user clicks the right answer of the first question and a weight of 20 is assigned to the second question if the user clicks the right answer of the second question.

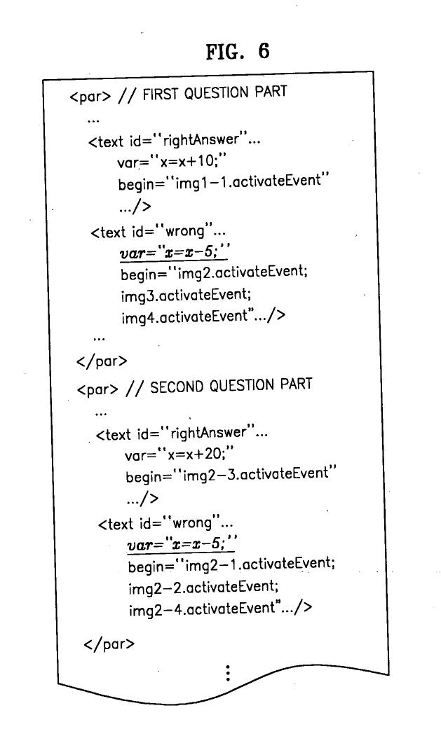

FIG. 6 shows another example of the SMIL content in FIG. 2.

According to FIG. 6, a demerit mark can be given to the wrong answer. That is, in the element <text id=“wrong” . . . /> of the first question part, var=“x=x−5” is inserted as an attribute that implements a memory function by expressing an operation on variables according to the present invention. In the element <text id=“wrong” . . . /> of the second question part, var=“x=x−5” is inserted as an attribute that implements a memory function by expressing an operation on variables according to the present invention. Thus, if the user clicks wrong answers to the first and second questions, demerit marks of 5 are given for each of the wrong answers to the first and second questions.

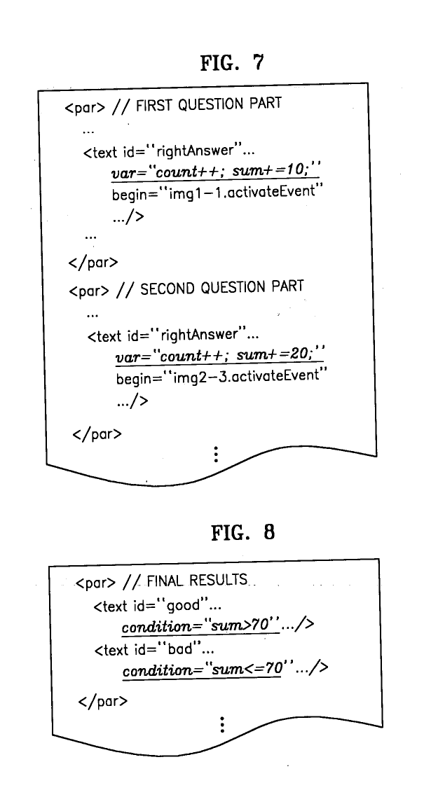

FIG. 7 shows another example of the SMIL content in FIG. 2.

Referring to FIG. 7, the number of right answers and marks are respectively calculated and stored for display to the user. That is, in the element <text id=“rightAnswer” . . . /> of the first question, var=“count++; sum+=10;?” is inserted as an attribute that implements a memory function by expressing an operation on variables according to the present invention. In the element <text id=“rightAnswer” . . . /> of the second question, var=“count++; sum+=20;” is inserted as an attribute that implements a memory function by expressing an operation on variables according to the present invention. Thus, the number of right answers and marks are simultaneously accumulated and stored.

Variables stored by the memory function using operations on the variables implemented in FIGS. 4 through 7 can be used in various ways.

FIG. 8 shows an example of using the variables stored by the memory function using operations on the variables implemented in FIGS. 4 through 7.

Referring to FIG. 8, a text element with the identifier “good” is used to display the results of operations on variables. The text element is executed only when the total marks exceed 70, thus outputting a corresponding text. Likewise, a text element with the identifier “bad” is also used to display the results of operations on variables. The text element is executed only when the total marks are at or below 70, thus outputting a corresponding text.

In the meanwhile, operations on variables for executing the function implemented in FIGS. 4 through 7 are generally processed when corresponding elements are parsed. However, the time when operations on variables are processed can be controlled by adding an executing condition.

FIG. 9 shows an example of adding a processing condition for processing operations on variables.

Referring to FIG. 9, the element <image id=“img1-1” . . ./> has var=“if (activeEvent){x++;}” inserted as an attribute that expresses an executing condition of the element. Thus, the result derived from whether the user selects the right answer or not is not outputted, but the number of right answers is stored and can be later outputted. That is, the variable x increases by 1 only when the user clicks the image with the identifier “img1-1”.

New attributes of SMIL according to the present invention can be described as follows. Table 1 shows attributes of SMIL, and table 2 shows detailed descriptions of the attributes.

TABLE 1

| Attribute name | Description |
|---|---|
| var | Phrase for an operation on variables |
| condition | Executing condition for a SMIL element |

TABLE 2

| Phrase | | Description |
|---|---|---|
| Arithmetic operation | +, −, *, / | Four fundamental rules of arithmetic |
| | | operation |
| | % | Modulus operator |
| | ++, −− | Increment and Decrement operations |
| Relational operation | >, < | Greater, Less than |
| | >=, <= | Greater than or equals, Less than or |
| | | equals |
| | ==, != | Equal, not equal |
| Logical operation | !, &&, ∥ | NOT, AND, OR |

| | |
|---|---|
| if | Variable processing condition |

TABLE 3

| Condition | | Description |
|---|---|---|
| Timing attribute of | begin, | SyncBase Timing |
| SMIL | end, | |
| | repeat | |
| | BeginEvent, | EventBase Timing |
| | EndEvent, | |
| | repeatEvent, | |
| | activateEvent | |

The processing condition on “if” may include a Timing attribute of the element defined by conventional SMIL as shown in table 3 and an operation attribute defined in table 2.

It is possible to add a function to the operation on variables. For example, it is not possible to express, using conventional SMIL, that two animation images disappear if they collide with each other while they are moving. Conventional SMIL can process one image, such that one image starts to move by using a Timing attribute defined in table 3 when another image has completed. However, conventional SMIL cannot process two images such that the two images collide with each other. The present invention can solve such a problem by adding a function to conventional SMIL.

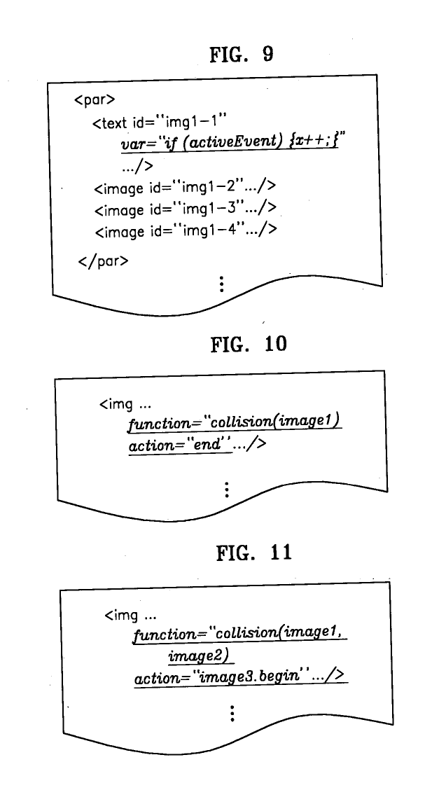

FIG. 10 shows an example of adding a function to SMIL content according to the present invention.

Referring to FIG. 10, a collision function is defined as true when rendering regions overlap. If the rendering region of an image with the identifier “image1” and a rendering region of the element <img . . ./> collide with each other, rendering of the element <img . . . /> is terminated by an action attribute including the collision function.

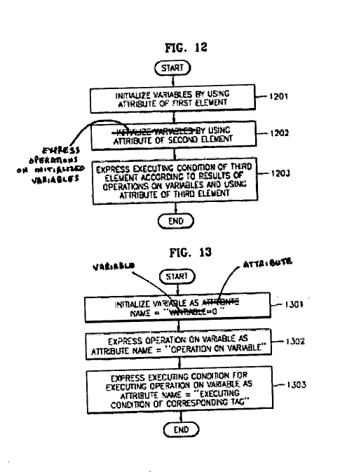

FIG. 11 shows another example of adding a function to SMIL content according to the present invention.

Referring to FIG. 11, if rendering regions of an image with an identifier “image1” and of an image with an identifier “image2” begin overlapping with each other, rendering of an image with an identifier “image3” starts.

As shown in FIGS. 10 and 11 where collision of the two rendering regions are processed using the action attribute, if a condition of a function is satisfied, the function should be processed. If fundamental contents of the function are predefined, it is possible to express the desired function by using the fundamental contents. Also, it is possible to make a profile or a component by grouping content according to type or grouping functions according to function. In addition, it is possible to define a new function by combining defined functions.

Hereinafter, a method of creating multimedia content according to an embodiment of the present invention will be described.

FIG. 12 is a flowchart for explaining a method of creating multimedia content using SMIL with additional attributes, according to an embodiment of the present invention.

Referring to FIG. 12, in order to implement a memory function by expressing operations on variables, according to the present invention, variables are initialized using an attribute of a first element (step 1201). Then, operations of the initialized variables are expressed by using an attribute of a second element (step 1202). The operations on the variables may be expressed using at least one of an arithmetic operation, a relational operation, a logical operation, or an “if” phrase. An executing condition of a third element is expressed according to the results of the operations on the variables and using an attribute of the third element (step 1203), which is previously described with reference to FIG. 8.

FIG. 13 is a flowchart for explaining a method of creating multimedia content using SMIL with additional attributes, according to another embodiment of the present invention.

Referring to FIG. 13, a variable is initialized as an attribute name=“variable=0;” to implement a memory function by expressing an operation on variables, according to the present invention (step 1301). For example, the variable is initialized as var=“x=0;”. Then, an operation on the variable is expressed as an attribute name=“operation on variable;” (step 1302). For example, the operation on the variable may be var=“x=x♦n” (here, ♦ is an arithmetic operator and n is a numeric value if required by the arithmetic operator). In addition, an executing condition for executing the operation on the variable is expressed as an attribute name=“executing condition of corresponding tag” (step 1303). For example, the executing condition for executing the operation on the variable may be var=“if phrase”.

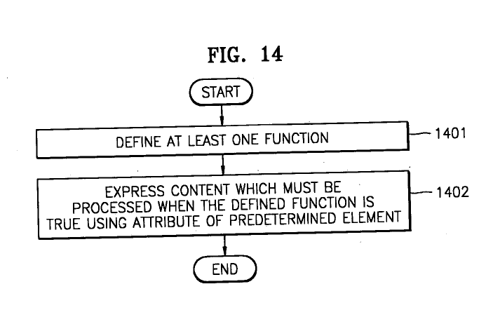

FIG. 14 is a flowchart for explaining a method of creating multimedia content using SMIL with an additional function, according to an embodiment of the present invention.

Referring to FIG. 14, at least one function is defined (step 1401). For example, a function is defined as true when rendering regions of an element and a corresponding element overlap with each other or when rendering regions of at least one element overlap with one another. Next, content, which must be processed when the defined function is true, is expressed using an attribute of a predetermined element (step 1402). For example, the content may be expressed using an “action” attribute. That is, rendering of the corresponding element can be completed or begun using the action attribute.

As described above, SMIL content according to the present invention has a memory function, thus it is possible to accumulate, store, and display results of user input using only SMIL content, without the need for connection to a server. That is, it is possible to simply implement a memory function using newly defined attributes of SMIL without additional programming. The SMIL content is effective particularly in a mobile environment due to the restrictions to resources in the mobile environment. Even developers who do not know a programming language can create SMIL content which supports user interaction.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. Multimedia content which is created using Synchronized Multimedia Integration Language (SMIL), the multimedia content comprising:
a first element which has a first attribute that initializes one or more variables; and
a second element which has a second attribute that implements a memory function by expressing one or more operations on one or more variables.

2. The multimedia content of claim 1, wherein the multimedia content further comprises a third element which expresses one or more results of the operations on the variables.

3. The multimedia content of claim 2, wherein the third element has a third attribute that expresses an executing condition of the third element.

4. The multimedia content of claim 1, wherein the second attribute of the second element expresses at least one from the group of an arithmetic operation, a relational operation, a logical operation, and an “if” phrase of the variables.

5. The multimedia content of claim 1, wherein the second attribute of the second element contains a processing condition for processing said one or more operations on said one or more variables.

6. The multimedia content of claim 1, wherein said one or more operations on said one or more variables of the second element are processed when the second element is parsed.

7. The multimedia content of claim 1, wherein the first attribute of the first element is expressed as a first attribute name=“variable=0;”, and the second attribute of the second element is expressed as a second attribute name “operation on variable”.

8. The multimedia content of claim 7, wherein the first attribute of the first element is expressed as var=“x=0;”, and the second attribute of the second element is expressed as var=“x=x♦n;” (here, ♦ is an arithmetic operator and n is a numeric value if required by the arithmetic operator).

9. The multimedia content of claim 7, wherein the first attribute of the first element is expressed as var=“x=0;”, and the second attribute of the second element is expressed as var=“count++; sum+=m;”, m being a numeric value.

10. The multimedia content of claim 8, wherein the third attribute of the third element is expressed as an attribute name=“executing condition of corresponding tag”.

11. The multimedia content of claim 10, wherein the attribute of the third element is expressed as condition=“executing condition”.

12. Multimedia content which are created using Synchronized Multimedia Integration Language (SMIL), the multimedia content comprising:
at least one element including a first element,
wherein said first element has an attribute that expresses a function for the first element and the content to be processed when the function is true.

13. Multimedia content of claim 12, wherein the function is true when a rendering region of the first element overlaps with a rendering region of a second element, and the attribute of the first element expresses ending rendering of the first element if the function is true.

14. Multimedia content of claim 12, wherein the function is true when rendering regions of a second element and a third element overlap with one another, and the attribute of the first element expresses beginning rendering of a predetermined element if the function is true.

15. A method of creating multimedia content using Synchronized Multimedia Integration Language (SMIL), the method comprising:
(a) initializing one or more variables by using a first attribute of a first element; and
(b) implementing a memory function by expressing one or more operations on said one or more variables by using a second attribute of a second element.

16. The method of claim 15, further comprising (c) expressing an executing condition of a third element according to one or more results from the operations on the variables using a third attribute of the third element.

17. The method of claim 15, wherein implementing a memory function in step (b) includes expressing at least one from the group of an arithmetic operation, a relational operation, a logical operation, and an “if” phrase of the variables.

18. The method of claim 15, wherein step (b) further comprises adding an executing condition for executing the operations on the variables.

19. The method of claim 18, wherein step (b) further comprises expressing the executing condition using timing attributes defined in SMIL.

20. The method of claim 15, wherein step (a) is initialized as var=“x=0;”, and the second element is initialized as var=“x=x♦n;” (here, ♦ is an arithmetic operator and n is a numeric value if required by the arithmetic operator).

21. A method of creating multimedia content using a Synchronized Multimedia Integration Language, the method comprising:
(a) defining at least one function in a first element; and
(b) expressing content to be processed when the function is true using an attribute of the first element.

22. The method of claim 21, wherein step (b) includes expressing the content to be processed using an “action” attribute of the first element.

23. The method of claim 21, wherein step (a) comprises defining the function as true when a rendering region of the first element overlaps with a rendering region of a second element, and step (b) includes completing rendering of the first element if the function is true.

24. The method of claim 21, wherein step (a) comprises defining a function as true when rendering regions of a second element and a third element overlap with one another, and step (b) includes starting rendering of a predetermined element using the action attribute.

25. A method of creating multimedia content, which is created using a Synchronized Multimedia Integration Language (SMIL), the method comprising:
(a) processing a first element, which defines one or more operations on one or more variables, by parsing the first element and implementing a function of memory.

26. The method of claim 25, wherein step (a) comprises parsing and processing the first element if each of one or more executing conditions of the first element are satisfied.

27. The method of claim 25, further comprising (b) parsing a second element with at least one defined function and processing the second element according to content to be processed when the function is true.

28. The method of claim 27, wherein step (b) further comprises processing the second element according to content expressed using the action attribute.
